(19) United States
(12) Patent Application Publication
(10) Pub. No.: US 2024/0037843 A1
(43) Pub. Date: Feb. 1, 2024

(54) IMAGE PROCESSING APPARATUS, IMAGE PROCESSING SYSTEM, IMAGE PROCESSING METHOD, AND STORAGE MEDIUM

(71) Applicant: CANON KABUSHIKI KAISHA, Tokyo (JP)

(72) Inventor: SHOHEI IWAMOTO, Kanagawa (JP)

(21) Appl. No.: 18/352,496

(22) Filed: Jul. 14, 2023

(30) Foreign Application Priority Data
Jul. 28, 2022 (JP) 2022-120653

(51) Int. Cl. G06T 15/20; G06T 19/00

(52) U.S. Cl. CPC G06T 15/20; G06T 19/00

(57) ABSTRACT

There is provided an image processing apparatus that generates a virtual viewpoint image on which an image indicating a position of a virtual viewpoint, a line-of-sight direction from the virtual viewpoint, and event information indicating an occurrence position of an event occurring at a time later than a time corresponding to the virtual viewpoint image is displayed in a superimposed manner.

### BACKGROUND OF THE DISCLOSURE

### Field of the Disclosure

The present disclosure relates to an image processing apparatus, an image processing system, an image processing method, and a storage medium for generating a virtual viewpoint image.

### Description of the Related Art

There is a technique for generating a virtual viewpoint image viewed from a camera (a virtual camera) virtually arranged in a three-dimensional space, by installing a plurality of imaging apparatuses at different positions to synchronously capture images from multiple viewpoints and generating a three-dimensional model using the plurality of images obtained through the image capturing. Japanese Patent Application Laid-open No. 2016-24490 discusses a technique in which a virtual camera is set to a desired position and orientation by an operator (a user) operating an operation unit to move and rotate an icon corresponding to the virtual camera on a display screen.

However, because the operator of the virtual camera operates the virtual camera while referring to the generated virtual viewpoint image, it is difficult for the operator to operate the virtual camera to include a sudden and unexpected event, such as traveling in a basketball game, at an appropriate position in the virtual viewpoint image.

### SUMMARY OF THE DISCLOSURE

The present disclosure is directed to an image processing apparatus that enables an operator to easily operate a virtual camera to include an event at an appropriate position in a virtual viewpoint image.

According to an aspect of the present disclosure, an image processing apparatus includes one or more memories storing instructions, and one or more processors executing the instructions to obtain a position of a virtual viewpoint corresponding to a virtual viewpoint image to be generated based on images captured by a plurality of imaging apparatuses, a line-of-sight direction from the virtual viewpoint, and event information about an event occurring at a second time later than a first time, the event information indicating an occurrence position of the event, and generate the virtual viewpoint image on which an image indicating the event information is superimposed and displayed, the virtual viewpoint image corresponding to the first time.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of an image processing system according to one or more aspects of the present disclosure.

FIG. 2 is a block diagram illustrating a hardware configuration of a virtual viewpoint image generation apparatus according to one or more aspects of the present disclosure.

FIG. 3 is a table illustrating an example of data managed by an event information storage apparatus according to one or more aspects of the present disclosure.

FIG. 4 is a flowchart illustrating an operation procedure for generating an image for an operator according to one or more aspects of the present disclosure.

FIG. 5 is a diagram illustrating an example of the image for the operator displayed when an event occurrence position is within an angle of view of a virtual camera according to one or more aspects of the present disclosure.

FIG. 6 is a diagram illustrating an example of the image for the operator displayed when the event occurrence position is not within the angle of view of the virtual camera according to one or more aspects of the present disclosure.

FIG. 7 is a block diagram illustrating a configuration example of an image processing system according to one or more aspects of the present disclosure.

FIG. 8 is a diagram illustrating an example of the image for the operator including virtual camera guide information according to one or more aspects of the present disclosure.

FIG. 9 is a diagram illustrating an example of the image for the operator including an image captured in real time according to one or more aspects of the present disclosure.

FIG. 10 is a diagram illustrating an example of the image for the operator including an overhead view image according to one or more aspects of the present disclosure.

### DESCRIPTION OF THE EMBODIMENTS

Exemplary embodiments of the present disclosure will be described below with reference to the attached drawings. The present disclosure is not intended to be limited to the following exemplary embodiments. In the drawings, the same members or components are assigned the same reference numerals, and the duplicate descriptions thereof will be omitted or simplified.

An image processing system according to a first exemplary embodiment generates a virtual viewpoint image representing a scene viewed from a designated virtual viewpoint, based on a plurality of images captured by a plurality of imaging apparatuses and the designated virtual viewpoint. In the present exemplary embodiment, a virtual viewpoint image is also referred to as a free viewpoint image, but is not limited to an image corresponding to a viewpoint freely (arbitrarily) designated by an operator (a user), and, for example, an image corresponding to a viewpoint selected by an operator from among a plurality of candidates is included in a virtual viewpoint image. In the present exemplary embodiment, a description will be given focusing on a case where a virtual viewpoint is designated by an operator's operation, but a virtual viewpoint may be automatically designated based on a result of an image analysis. In the present exemplary embodiment, a description will be given focusing on a case where a virtual viewpoint image is a moving image, but a virtual viewpoint image may be a still image.

Viewpoint information used for generating a virtual viewpoint image is information indicating a position and an orientation (a line-of-sight direction) of a virtual viewpoint. More specifically, the viewpoint information is a parameter set including a parameter representing a three-dimensional position of a virtual viewpoint, and a parameter representing an orientation of the virtual viewpoint in pan, tilt, and roll directions. However, the contents of the viewpoint information are not limited thereto. For example, the parameter set as the viewpoint information may include a parameter representing a size of a field of view (an angle of view) of the virtual viewpoint. The viewpoint information may also include a plurality of parameter sets. For example, the viewpoint information may include a plurality of parameter sets respectively corresponding to a plurality of frames included in a moving image as a virtual viewpoint image, and indicate the position and orientation of the virtual viewpoint at each of consecutive time points.

The image processing system according to the present exemplary embodiment includes a plurality of imaging apparatuses for capturing images of an imaging area from a plurality of directions. The imaging area is, for example, a sport stadium where a competition such as a soccer game or a karate fight is performed, or a stage where a concert or a theatrical play is performed. The plurality of imaging apparatuses is installed at different positions around the imaging area to perform synchronous imaging. The plurality of imaging apparatuses may not necessarily be installed all around the imaging area, and may be installed at a part of positions around the imaging area, depending on the limitation of the installation position. The number of imaging apparatuses is not limited to the illustrated example, and, for example, in a case where the imaging area is an athletic field for soccer, about thirty imaging apparatuses may be installed around the athletic field. Imaging apparatuses different in function, such as telephoto cameras and wide-angle cameras, may also be installed.

In the present exemplary embodiment, the plurality of imaging apparatuses is assumed to be cameras each having an independent housing and capable of capturing an image from a single viewpoint. However, the present exemplary embodiment is not limited thereto, and two or more imaging apparatuses may be included in the same housing. For example, a single camera including a plurality of lens groups and a plurality of image sensors and capable of capturing images from a plurality of viewpoints may be installed as the plurality of imaging apparatuses.

A virtual viewpoint image is generated, for example, using the following method. First, a plurality of images (multi-viewpoint images) is obtained by the plurality of imaging apparatuses capturing images from different directions. Next, from the multi-viewpoint images, a foreground image is obtained by extracting a foreground area corresponding to a predetermined object such as a person or a ball, and a background image is obtained by extracting a background area other than the foreground area. Further, a foreground model representing a three-dimensional shape of a predetermined object, and texture data for coloring the foreground model are generated based on the foreground image, and texture data for coloring a background model representing a three-dimensional shape of a background such as an athletic field is generated based on the background image. Then, a virtual viewpoint image is generated by mapping the texture data on the foreground model and the background model, and performing rendering based on the virtual viewpoint indicated by the viewpoint information. The method for generating a virtual viewpoint image is not limited thereto, and various methods, such as a method of generating a virtual viewpoint image by using projective transformation of captured images without using three-dimensional models, can be used.

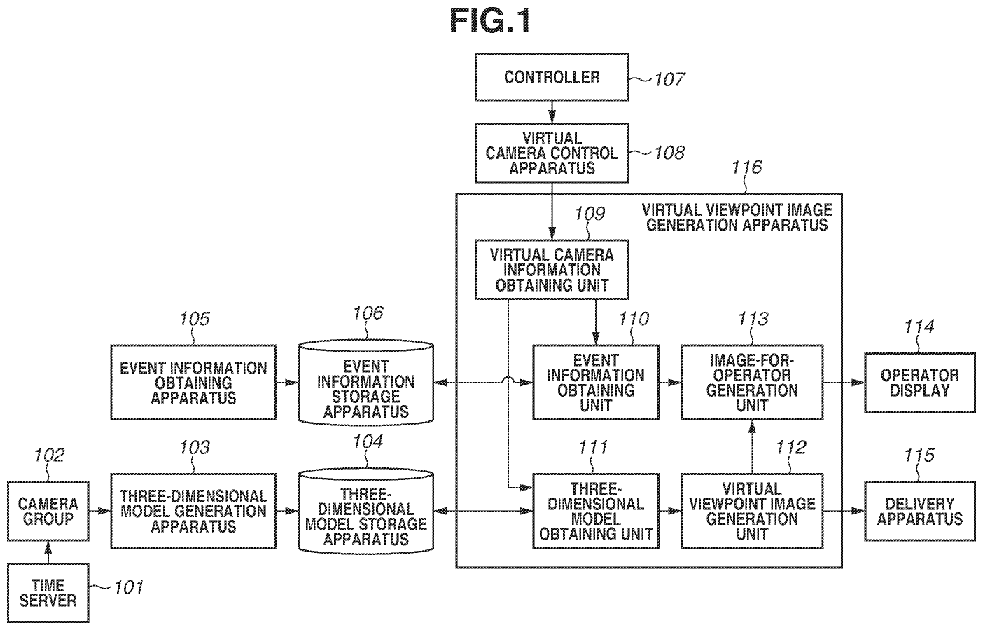

FIG. 1 is a block diagram illustrating a configuration example of the image processing system according to the present exemplary embodiment.

A time server 101 sets a time code for a camera group 102 to perform synchronous imaging, and transmits the time code to the camera group 102.

The camera group 102 performs all-camera synchronous imaging in order to generate a three-dimensional model of a subject. The synchronous imaging is performed based on time information supplied from the time server 101, and the camera group 102 adds the imaging time information to the captured images, and outputs the images to a three-dimensional model generation apparatus 103.

The three-dimensional model generation apparatus 103 obtains the images captured by the camera group 102 and generates a three-dimensional model. In the present exemplary embodiment, the method for generating a three-dimensional model is not specifically limited, but, for example, a three-dimensional model may be generated based on a silhouette image as in a visual hull method. Alternatively, the camera group 102 may be configured to include distance sensors, and a three-dimensional model may be generated based on a depth map obtained from the distance sensors.

A three-dimensional model storage apparatus 104 stores the three-dimensional model generated by the three-dimensional model generation apparatus 103, in association with the imaging time information. Based on a virtual viewpoint image generation time received from a three-dimensional model obtaining unit 111, the three-dimensional model storage apparatus 104 also transmits, to the three-dimensional model obtaining unit 111, a three-dimensional model associated with the imaging time information corresponding to the virtual viewpoint image generation time. The virtual viewpoint image generation time is set via a controller 107 as a time of a virtual viewpoint image that an operator of a virtual camera wishes to generate. The virtual viewpoint image generation time is not limited to the one set via the controller 107, and may be set by a virtual camera control apparatus 108 or an external apparatus (not illustrated).

An event information obtaining apparatus 105 obtains event information about an event that has occurred with a subject, such as traveling or blocking in a basketball game. In the present exemplary embodiment, a description will be given taking basketball as an example, but the event is not limited thereto. The event may be an event in another sport such as a soccer or a track and field competition, or an event in a concert or a horse racing. In the present exemplary embodiment, the event information includes any one of an event occurrence time, an event occurrence position, an event-related subject, and an event type. The method for obtaining the event information is not limited to a specific method in the present exemplary embodiment. For example, the event information obtaining apparatus 105 may detect an event based on a result of image processing on the images captured by the camera group 102 and obtain the detected event as the event information. Based on a position of the three-dimensional model or information from a global positioning system (GPS) sensor attached to a subject, the event information obtaining apparatus 105 can obtain the event occurrence position. Alternatively, based on a signal obtained from a sensor such as a goal sensor or a starter pistol sensor in a track and field competition, or a sword tip sensor in fencing, the event information obtaining apparatus 105 may obtain the event information. Further alternatively, based on an analysis result of an audio signal obtained through an audio recording apparatus such as a microphone, the event information obtaining apparatus 105 may obtain the event information. Yet further alternatively, after the occurrence of the event, the event information obtaining apparatus 105 may obtain the event information when the event content is manually input. The event information may not necessarily be information about a predetermined event. For example, information about a point or a play which an announcer or a commentator focuses on may be obtained as the event information.

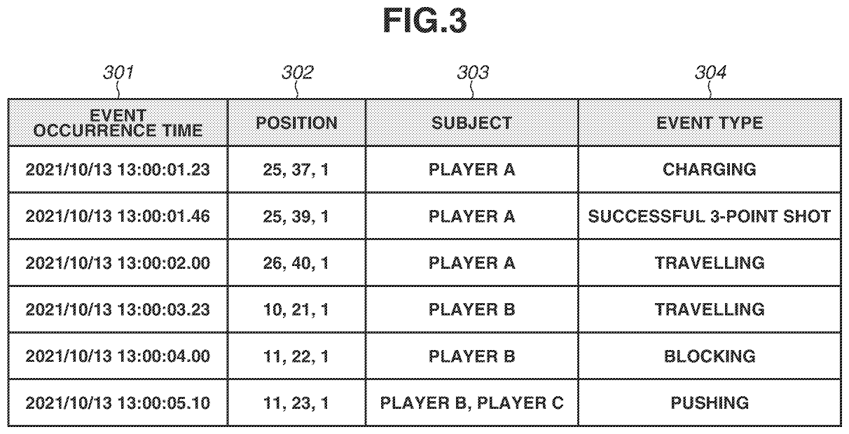

An event information storage apparatus 106 stores the event information obtained by the event information obtaining apparatus 105 and manages the stored event information using a table illustrated in FIG. 3. The event information storage apparatus 106 also obtains the virtual viewpoint image generation time from an event information obtaining unit 110, and transmits, to the event information obtaining unit 110, the event information about an event that has occurred during a predetermined time period (e.g., several seconds) from the obtained virtual viewpoint image generation time. In a case where there is a plurality of subjects involved in an event, all the subjects involved in the event may be recorded or only a representative subject may be recorded. In the present exemplary embodiment, two subjects involved in a pushing foul event, one committing the foul and the other receiving the foul, are recorded.

The controller 107 is a controller including a joy stick, but is not limited thereto. The controller 107 can be a tablet terminal including a touch panel, a keyboard, or a mouse. The operator of the virtual camera operates the controller 107 to operate the virtual camera while watching an operator display 114 (described below). Operation information obtained through the operation is transmitted to the virtual camera control apparatus 108. The operation information is information based on the operation on the controller 107, such as whether any of buttons to which functions are assigned is pressed on the controller 107, or how much the joy stick for controlling the movement or position of the virtual camera is tilted. The operation information includes the virtual viewpoint image generation time.

The virtual camera control apparatus 108 generates virtual camera information, such as the position, orientation, and angle of view of the virtual camera, based on the operation information received from the controller 107, and transmits the generated virtual camera information to a virtual camera information obtaining unit 109. The virtual camera information includes at least the virtual viewpoint image generation time.

The virtual camera information obtaining unit 109 transmits the virtual camera information obtained from the virtual camera control apparatus 108 to the event information obtaining unit 110 and the three-dimensional model obtaining unit 111.

The event information obtaining unit 110 transmits, to the event information storage apparatus 106, the virtual viewpoint image generation time included in the virtual camera information obtained from the virtual camera information obtaining unit 109. The event information obtaining unit 110 then obtains, from the event information storage apparatus 106, the event information about an event that has occurred within several seconds from the virtual viewpoint image generation time. In the present exemplary embodiment, the event information includes the event occurrence time, the event occurrence position, the subject, and the event type (the event name), but is not limited thereto. The event information includes at least the event occurrence time and the event occurrence position. A priority may be given based on the event type. The event information is associated with the time code set by the time server 101. The event information obtaining unit 110 further transmits the obtained virtual camera information and the obtained event information to an image-for-operator generation unit 113.

Based on the virtual viewpoint image generation time included in the virtual camera information obtained from the virtual camera information obtaining unit 109, the three-dimensional model obtaining unit 111 obtains the three-dimensional model associated with the corresponding time from the three-dimensional model storage apparatus 104. The three-dimensional model obtaining unit 111 further transmits the obtained virtual camera information and the obtained three-dimensional model to a virtual viewpoint image generation unit 112.

The virtual viewpoint image generation unit 112 generates a virtual viewpoint image based on the three-dimensional model and the virtual camera information obtained from the three-dimensional model obtaining unit 111. More specifically, the virtual viewpoint image generation unit 112 generates, as a virtual viewpoint image, an image captured by the virtual camera indicated by the virtual camera information, based on the obtained three-dimensional model. The virtual viewpoint image generation unit 112 stores three-dimensional background data separately in advance, and generates a virtual viewpoint image by combining the obtained three-dimensional model and the three-dimensional background data. In the present exemplary embodiment, the description is given assuming that the three-dimensional background data is generated in advance, but a captured image of a background portion can be combined. In the present exemplary embodiment, the virtual viewpoint image is generated in association with the time code managed by the time server 101. The virtual viewpoint image generation unit 112 transmits the generated virtual viewpoint image to a delivery apparatus 115. In the present exemplary embodiment, the transmission destination of the virtual viewpoint image is not limited to the delivery apparatus 115. For example, a device such as a display may be the transmission destination.

The generated virtual viewpoint image is also transmitted to the image-for-operator generation unit 113.

The image-for-operator generation unit 113 generates an image for the operator based on the event information and the virtual camera information obtained from the event information obtaining unit 110, and the virtual viewpoint image obtained from the virtual viewpoint image generation unit 112. The image for the operator is an image obtained by superimposing information, such as an event occurrence position, a subject, an event type, and a countdown time before the event occurrence, on the virtual viewpoint image. For example, the image-for-operator generation unit 113 generates a message such as “<PLAYER A> TIME LEFT UNTIL OCCURRENCE OF TRAVELING 00:00:04.23” and superimposes the generated message on the virtual viewpoint image. The image-for-operator generation unit 113 displays a three-dimensional virtual object or an icon indicating the event occurrence at the event occurrence position. The image-for-operator generation unit 113 calculates the countdown time before the event occurrence, based on the event occurrence time such as an event occurrence time 301 (see FIG. 3) and the virtual viewpoint image generation time included in the virtual camera information. Since each of the virtual viewpoint image and the event information is associated with the time code, the image-for-operator generation unit 113 may calculate the countdown time based on a difference in time code between the virtual viewpoint image and the event information. The image-for-operator generation unit 113 transmits the generated image for the operator to the operator display 114. In the present exemplary embodiment, the transmission destination is not limited to a display, and can be any device on which the operator can view the image. In the present exemplary embodiment, the time period from the virtual viewpoint image generation time to the event occurrence time is indicated by the display of the countdown time, but the present exemplary embodiment is not limited thereto. For example, the event occurrence time can be displayed, or the time period can be expressed by using a color, a size, or a blinking interval of a displayed icon instead of using text or a number.

For example, if the countdown value before the event occurrence is relatively large, the length of the time before the occurrence can be expressed in green, and the color can be changed to yellow and red as the countdown value becomes small. In a similar manner, the length of the time can be indicated by making the text, the number, or the icon smaller if the countdown value is larger, and by making the text, the number, or the icon larger if the countdown value is smaller. As for the blinking interval, the length of the time can be indicated by making the blinking interval longer if the countdown value is larger, and gradually making the blinking interval shorter as the countdown value becomes smaller. In the present exemplary embodiment, the case where one piece of the event information is superimposed has been described, but the present exemplary embodiment is not limited thereto, and a plurality of pieces of the event information may be displayed.

The operator display 114 displays the virtual viewpoint image received from a virtual viewpoint image generation apparatus 116. The displayed virtual viewpoint image is the virtual viewpoint image generated by the image-for-operator generation unit 113, and includes the event information. The operator of the virtual camera operates the virtual camera via the controller 107 with reference to the virtual viewpoint image on which the event information is displayed.

The delivery apparatus 115 delivers the virtual viewpoint image received from the virtual viewpoint image generation apparatus 116. The virtual viewpoint image to be delivered is the virtual viewpoint image generated by the virtual viewpoint image generation unit 112, not the image in which the event information is displayed on the virtual viewpoint image. However, the virtual viewpoint image to be delivered is not limited thereto, and the delivery apparatus 115 may deliver the virtual viewpoint image, which includes the event information, generated by the image-for-operator generation unit 113.

The virtual viewpoint image generation apparatus 116 includes the virtual camera information obtaining unit 109, the event information obtaining unit 110, the three-dimensional model obtaining unit 111, the virtual viewpoint image generation unit 112, and the image-for-operator generation unit 113. However, the configuration of the virtual viewpoint image generation apparatus 116 is not limited to the configuration described above, and may include at least one of the controller 107, the virtual camera control apparatus 108, and the operator display 114.

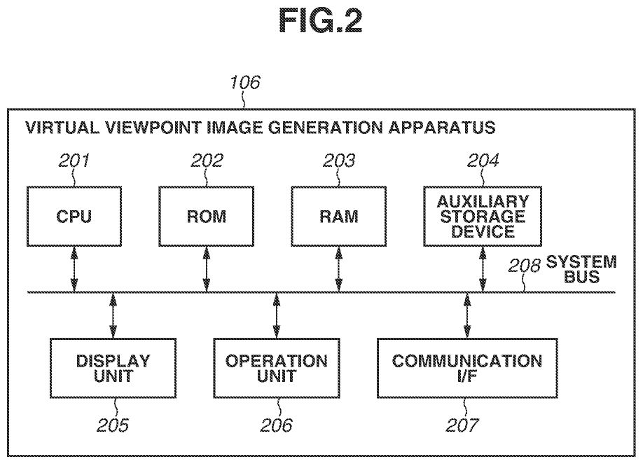

FIG. 2 is a block diagram illustrating a hardware configuration of the virtual viewpoint image generation apparatus 116. Hardware configurations of the three-dimensional model generation apparatus 103, the three-dimensional model storage apparatus 104, the event information obtaining apparatus 105, the event information storage apparatus 106, the virtual camera control apparatus 108, and the delivery apparatus 115 are similar to the configuration of the virtual viewpoint image generation apparatus 116 described next. The virtual viewpoint image generation apparatus 116 includes a central processing unit (CPU) 201, a read-only memory (ROM) 202, a random access memory (RAM) 203, an auxiliary storage device 204, a display unit 205, an operation unit 206, a communication interface (UF) 207, and a system bus 208.

The CPU 201 implements the functions of the virtual viewpoint image generation apparatus 116 illustrated in FIG. 1 by controlling the entire virtual viewpoint image generation apparatus 116 using computer programs and data stored in the ROM 202 or the RAM 203. Alternatively, the virtual viewpoint image generation apparatus 116 may include one or more dedicated hardware components different from the CPU 201, and at least part of the processing by the CPU 201 may be executed by the one or more dedicated hardware components. Examples of the dedicated hardware components include an application specific integrated circuit (ASIC), a field programmable gate array (FPGA), and a digital signal processor (DSP). The ROM 202 stores programs that do not need to be changed. The RAM 203 temporarily stores programs or data supplied from the auxiliary storage device 204, and data externally supplied via the communication OF 207. The auxiliary storage device 204 is, for example, a hard disk drive, and stores various kinds of data such as image data and audio data.

The display unit 205 includes, for example, a liquid crystal display or light- emitting diodes (LEDs), and displays a graphical user interface (GUI) for the operator to operate the virtual viewpoint image generation apparatus 116. The operation unit 206 includes, for example, a keyboard, a mouse, a joy stick, and/or a touch panel, and inputs various instructions to the CPU 201 in response to an operator's operation. The CPU 201 operates as a display control unit for controlling the display unit 205 and an operation control unit for controlling the operation unit 206. The communication OF 207 is used to communicate with an external apparatus outside the virtual viewpoint image generation apparatus 116. For example, in a case where the virtual viewpoint image generation apparatus 116 is connected to an external apparatus by wire, a communication cable is connected to the communication OF 207.

In a case where the virtual viewpoint image generation apparatus 116 has a function of wirelessly communicating with an external apparatus, the communication OF 207 includes an antenna. The system bus 208 connects the components of the virtual viewpoint image generation apparatus 116 to transmit information therebetween.

In the present exemplary embodiment, the display unit 205 and the operation unit 206 are included in the virtual viewpoint image generation apparatus 116, but at least one of the display unit 205 and the operation unit 206 may be externally provided as a separate apparatus.

FIG. 3 is an example of data managed by the event information storage apparatus 106.

The event occurrence time 301 indicates a time (a time code) when an event has occurred.

In the present exemplary embodiment, the storage format of the time is “Year/Month/Day Hour:Minute:Second.Frame”, and the frame rate is 60 frames per second (fps). In other words, the frame can take a value from 0 to 59. However, the present exemplary embodiment is not limited thereto.

A position 302 indicates a position at which an event has occurred. In the present exemplary embodiment, the storage format is “X coordinate, Y coordinate, and Z coordinate”, and the unit is meter. However, the present exemplary embodiment is not limited thereto, and the position 302 may be expressed by polar coordinates, and the unit may be foot.

A subject 303 indicates a subject involved in an event.

An event type 304 indicates what type of event has occurred. In the present exemplary embodiment, event types in a basketball game are described. Event types may be determined in advance depending on the sport or the play to be imaged, or may be briefly expressed on the spot.

Other than the items described above, an index indicating an importance level of an event may be set. More specifically, the importance level is set based on the subject or the event type. If the event is related to a famous subject, the importance level is set high, and for a specific event type, such as a successful dunk shot or 3-point shot in a basketball game, the importance level is set high. On the other hand, the importance level of an event related to a referee may be set low.

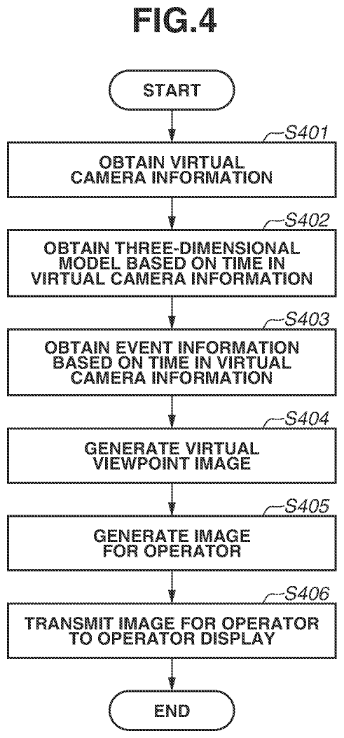

FIG. 4 is a flowchart illustrating processing for generating the image for the operator by the virtual viewpoint image generation apparatus 116.

In step S401, the virtual viewpoint image generation apparatus 116 obtains the virtual camera information from the virtual camera control apparatus 108. The virtual camera information includes the virtual viewpoint image generation time, in addition to information such as the position, orientation, and angle of view of the virtual camera.

In step S402, based on the virtual viewpoint image generation time obtained in step S401, the virtual viewpoint image generation apparatus 116 obtains, from the three-dimensional model storage apparatus 104, the three-dimensional model associated with the imaging time corresponding to the virtual viewpoint image generation time.

In step S403, the event information obtaining unit 110 obtains the event information from the event information storage apparatus 106, based on the virtual viewpoint image generation time obtained in step S401. In the present exemplary embodiment, the event information obtaining unit 110 obtains the event information about an event that has occurred within 10 seconds from the virtual viewpoint image generation time. The threshold value for determining within how many seconds from the virtual viewpoint image generation time the event information is to be obtained may be set in advance, or may be dynamically changed. For example, the importance level of an event is set in advance, and the threshold value may be set based on the importance level of the event. More specifically, the event information obtaining unit 110 obtains the event information within 15 seconds from the virtual viewpoint image generation time for an event with a high importance level, and obtains the event information within 7 seconds from the virtual viewpoint image generation time for an event with a low importance level. The event information obtaining unit 110 may obtain a plurality of pieces of the event information until a set time after the virtual viewpoint image generation time. More specifically, the event information obtaining unit 110 obtains three pieces of the event information within 10 seconds from the virtual viewpoint image generation time. A plurality of conditions for obtaining the event information may be set.

More specifically, in a case where there are five pieces of the event information in 10 seconds from the virtual viewpoint image generation time, the event information obtaining unit 110 obtains three pieces of the event information in descending order of the importance level.

In step S404, the virtual viewpoint image generation unit 112 generates a virtual viewpoint image based on the virtual camera information obtained in step S401, the three-dimensional model obtained in step S402, and the three-dimensional background data stored in advance.

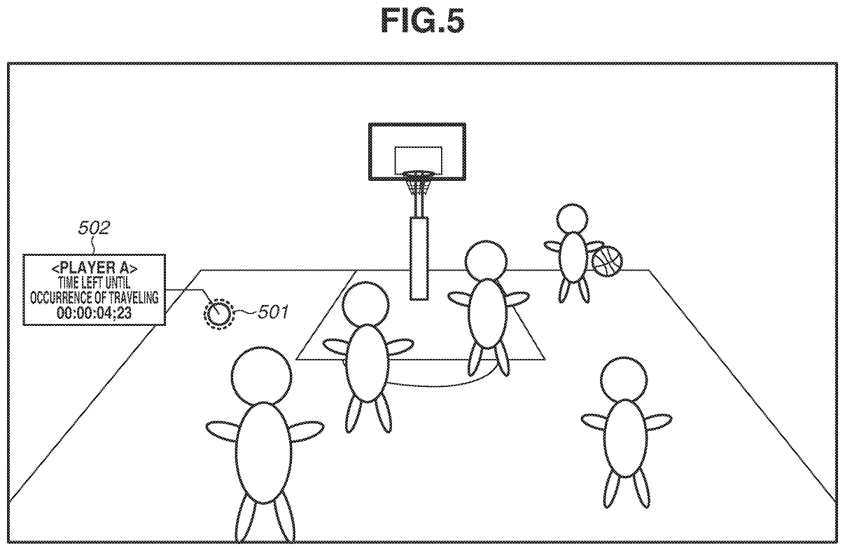

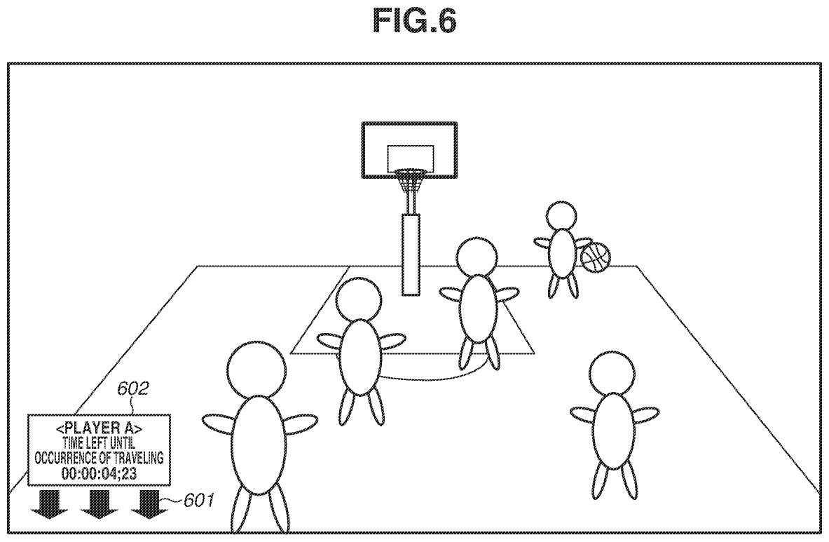

In step S405, the image-for-operator generation unit 113 generates the image for the operator based on the virtual viewpoint image generated in step S404, the virtual camera information obtained in step S401, and the event information obtained in step S403. At this time, the image-for-operator generation unit 113 changes the display method of the event information to be superimposed on the virtual viewpoint image, depending on whether the obtained event occurrence position is within the angle of view of the virtual camera. The display method will be specifically described below with reference to FIGS. 5 and 6. In the image for the operator, text, a number, a three-dimensional virtual object, or an icon indicating the event information is displayed. In a case where a three-dimensional virtual object is displayed as the event information, the image-for-operator generation unit 113 generates the image for the operator by superimposing or compositing, on the virtual viewpoint image, an image of the three-dimensional virtual object viewed from the virtual camera.

In step S406, the image-for-operator generation unit 113 transmits the image for the operator generated in step S405 to the operator display 114.

Through the processing described above, the image-for-operator generation unit 113 can generate the image in which the event information about an event that has occurred within several seconds from the virtual viewpoint image generation time is displayed on the virtual viewpoint image. Accordingly, the operator of the virtual camera can operate the virtual camera suitably for the event because the occurrence time and position of the event that is about to occur are displayed on the virtual viewpoint image being used as a reference during the operation.

In the present exemplary embodiment, it is assumed that the text, number, three-dimensional virtual object, or icon indicating the event information superimposed or composited on the virtual viewpoint image is generated by the virtual viewpoint image generation apparatus 116. However, the present exemplary embodiment is not limited thereto, and a template of an image indicating the event information, the three-dimensional virtual object, or the icon may be stored in advance.

FIG. 5 illustrates an example of the image for the operator displayed when the event occurrence position is within the angle of view of the virtual camera. In the example of FIG. 5, a spherical object (a three-dimensional virtual object) 501 indicating the event occurrence position and an image 502 indicating the subject, the event type, and the countdown time are superimposed and displayed on a virtual viewpoint image in a basketball game. Thus, the operator of the virtual camera can operate the virtual camera after identifying when and where the event is to occur in the virtual viewpoint image. This enables the operator to easily operate the virtual camera to include a particular event, such as traveling, at an appropriate position in the virtual viewpoint image. An effect of emphasizing an outline of the subject related to the event, or an icon may also be displayed. In this case, the operator can more easily operate the virtual camera to include the event at an appropriate position in the virtual viewpoint image because the operator can visually identify the event occurrence position and the subject.

FIG. 6 illustrates an example of the image for the operator displayed when the event occurrence position is not within the angle of view of the virtual camera. Similarly to the example of FIG. 5, in the example of FIG. 6, an arrow (an icon) 601 indicating the direction of the event occurrence position and an image 602 indicating the subject, the event type, and the countdown time are superimposed and displayed on the virtual viewpoint image. In the present exemplary embodiment, the arrow 601 is displayed to roughly indicate, in a case where the position at which traveling is about to occur is outside the angle of view of the currently displayed virtual viewpoint image, the position outside the angle of view at which the traveling is about to occur. The display for indicating the direction of the event occurrence position is not limited to the icon, and an effect of blinking the edge of the image closer to the event occurrence position may be used for the display.

As described above, in the present exemplary embodiment, the image in which the event occurrence position and the countdown time before the event occurrence are displayed in a superimposed manner on the virtual viewpoint image is presented to the operator of the virtual camera, as the image for the operator. This enables the operator of the virtual camera to easily operate the virtual camera to include the event at an appropriate position in the virtual viewpoint image in consideration of the occurrence time and position of the event that is to occur after several seconds.

In the present exemplary embodiment, the three-dimensional model of the subject is estimated from real images, but the present exemplary embodiment is not limited thereto and the three-dimensional model may be estimated using a motion capture for generating a computer graphics (CG) image based on joint positions obtained by imaging of joints with markers.

In the first exemplary embodiment described above, the description has been given of the method of superimposing and displaying the event occurrence position and the countdown time before the event occurrence on the virtual viewpoint image. A skilled operator of the virtual camera can easily capture the virtual viewpoint image including the event at an appropriate position, by operating the virtual camera based on the above-described information. However, it is difficult for an unskilled operator of the virtual camera to imagine how to operate the virtual camera to include the event at an appropriate position in the virtual viewpoint image based only on the above-described information. As a result, there is a possibility that the unskilled operator may not be able to guide the virtual camera to an appropriate position. To address the issue, in a second exemplary embodiment, a description will given of a configuration of displaying virtual camera guide information indicating how to operate the virtual camera, in addition to superimposing the event occurrence position and the countdown time before the event occurrence on the virtual viewpoint image.

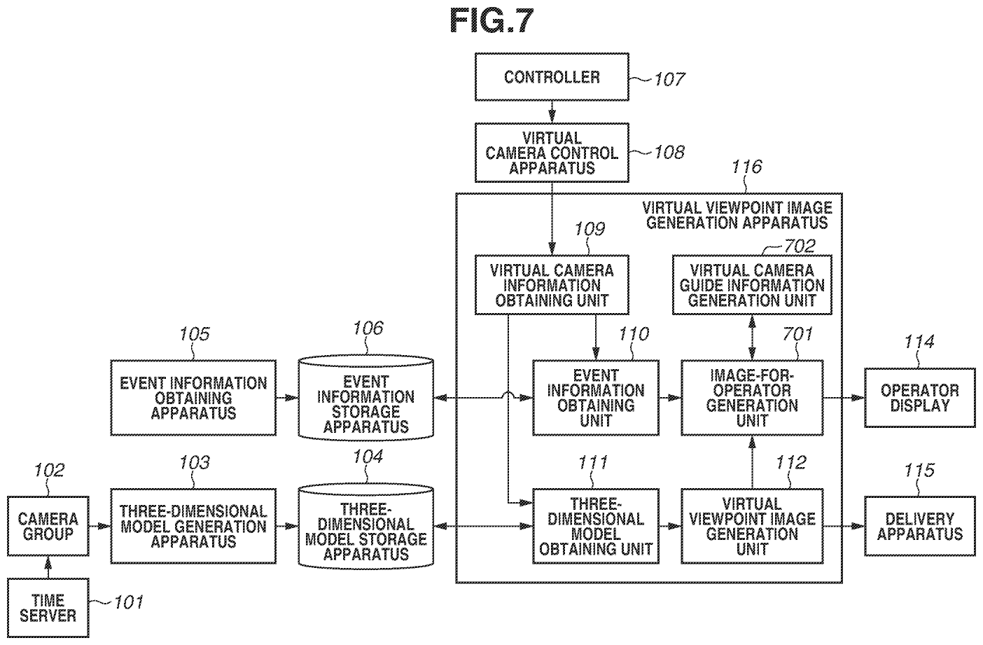

FIG. 7 is a block diagram illustrating a configuration example of an image processing system according to the present exemplary embodiment. Components other than an image-for-operator generation unit 701 and a virtual camera guide information generation unit 702 are similar to those illustrated in FIG. 1, and the descriptions thereof will thus be omitted.

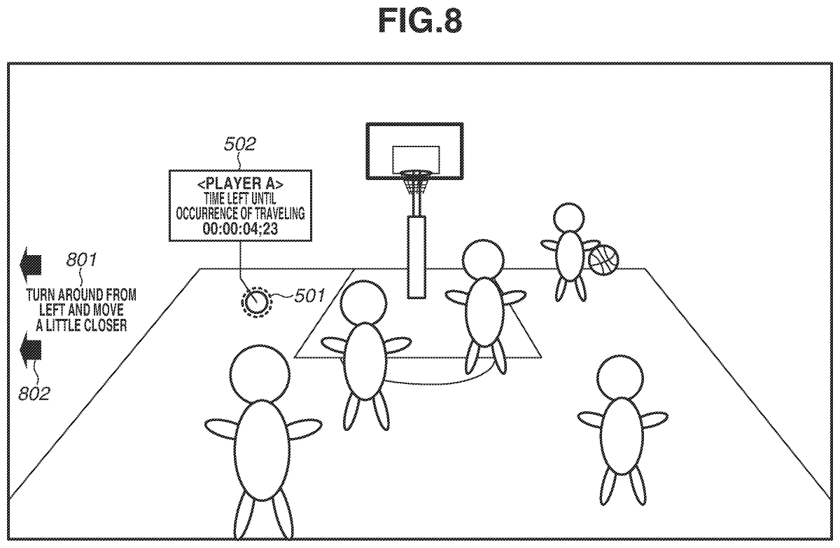

The image-for-operator generation unit 701 has the following function in addition to the function of the image-for-operator generation unit 113 described with reference to FIG. 1. More specifically, the image-for-operator generation unit 701 transmits the virtual camera information and the event information to the virtual camera guide information generation unit 702. The image-for-operator generation unit 701 also obtains the virtual camera guide information from the virtual camera guide information generation unit 702, and generates the image for the operator by superimposing the obtained virtual camera guide information on the virtual viewpoint image. The virtual camera guide information generation unit 702 generates the virtual camera guide information indicating how to operate the virtual camera properly, based on the virtual camera information and the event information obtained from the image-for-operator generation unit 701. An example of the virtual camera guide information is information for presenting, to the operator, how to operate the virtual camera properly, such as a message 801 in FIG. 8 saying “TURN AROUND FROM LEFT AND MOVE A LITTLE CLOSER”. The virtual camera guide information generation unit 702 then transmits the generated virtual camera guide information to the image-for-operator generation unit 701. The method for generating the virtual camera guide information is not specifically limited in the present exemplary embodiment. One example thereof is that positional relationships between event positions and virtual camera positions are classified into several patterns in advance, and in a case where any of the patterns is matched, a message prepared in advance is presented to the operator. For example, it is possible to implement the method by detecting a camera position and a movement of a subject causing an event and determining, if the event is, for example, traveling, a pattern such as capturing the image from the side of the subject in a moving direction so that the event can be easily understood. Alternatively, an optimum message may be generated by learning of a previous operation history to apply a prediction using machine learning.

FIG. 8 illustrates an example of the image for the operator including the virtual camera guide information. The message 801 and an arrow 802 for guiding the virtual camera (which are the virtual camera guide information) are displayed in a superimposed manner on the virtual viewpoint image, in addition to the spherical object (the three-dimensional virtual object) 501 indicating the event occurrence position and the image 502 indicating the subject, the event type, and the countdown time. This enables the operator of the virtual camera to more easily operate the virtual camera to include a particular event, such as traveling, at an appropriate position in the virtual viewpoint image than in the first exemplary embodiment.

As described above, in the present exemplary embodiment, the description has been given of the method of superimposing and displaying the virtual camera guide information on the virtual viewpoint image, in addition to the event occurrence position and the countdown time before the event occurrence. This enables even an unskilled operator of the virtual camera to easily operate the virtual camera to capture a sudden and unexpected event in an appropriate angle of view.

While in the present exemplary embodiment, the description has been given of the configuration of superimposing and displaying the virtual camera guide information on the virtual viewpoint image, the configuration may be such that the virtual camera is automatically operated when the operator taps or clicks, with a mouse, a portion where the virtual camera guide information is superimposed.

In the first and second exemplary embodiments, the description has been given of the method of superimposing and displaying the event occurrence position and the countdown time before the event occurrence on the virtual viewpoint image. However, there is a possibility that the operator may result in failing to guide the virtual camera to an appropriate position even though the operator operates the virtual camera so as to include the event in the virtual viewpoint image, because a subject not involved in the event is located in front of the target subject. To address the issue, in a third exemplary embodiment, an image captured at a time later than the virtual viewpoint image generation time is superimposed and displayed in addition to the event occurrence position and the countdown time before the event occurrence.

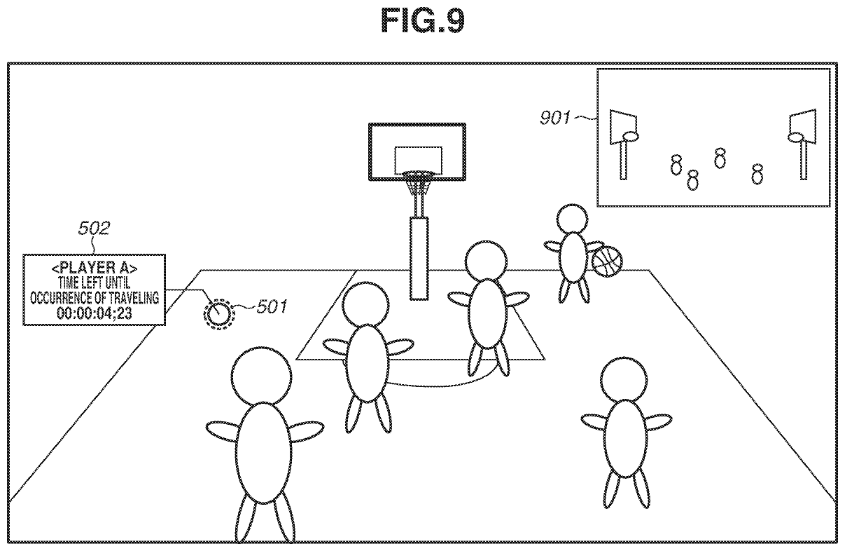

FIG. 9 illustrates an example of the image for the operator including an image captured in real time. Items other than a real image 901 are similar to those illustrated in FIG. 5, and the descriptions thereof will thus be omitted.

The real image 901 is an image captured in real time. In the present exemplary embodiment, it is assumed that any of images captured by the camera group 102 is directly superimposed on the virtual viewpoint image, but the present exemplary embodiment is not limited thereto. The real image 901 may be an image captured by an imaging apparatus different from the camera group 102. The real image 901 is also not limited to an image captured in real time, and can be a captured image corresponding to a time later than the virtual viewpoint image generation time.

With the configuration described above, the operator can identify what the area around the event occurrence position is like at the time of the event occurrence, and easily operate and guide the virtual camera to an appropriate position in consideration of a subject not involved in the event. Even in a case where the event information is unable to be obtained because of a condition in imaging, a malfunction of the event information obtaining apparatus 105, or the like, the operator can recognize the occurrence of the event and the event occurrence position because the real image 901 is displayed. In the present exemplary embodiment, an image captured in real time is displayed in a superimposed manner on the image for the operator, but the display method is not limited thereto, and the image captured in real time and the image for the operator may be displayed side by side.

In the first exemplary embodiment, with reference to FIG. 6, the description has been given of the image for the operator in a case where the event occurrence position is not within the angle of view of the virtual camera. However, since the information about the event occurrence position displayed on the image for the operator is the icon or the effect indicating the direction of the event occurrence position, the operator is unable to identify the event occurrence position accurately. To address the issue, in a fourth exemplary embodiment, a description will be given of a case where an overhead view image indicating the event occurrence position is superimposed and displayed in addition to the direction of the event occurrence position and the countdown time before the event occurrence.

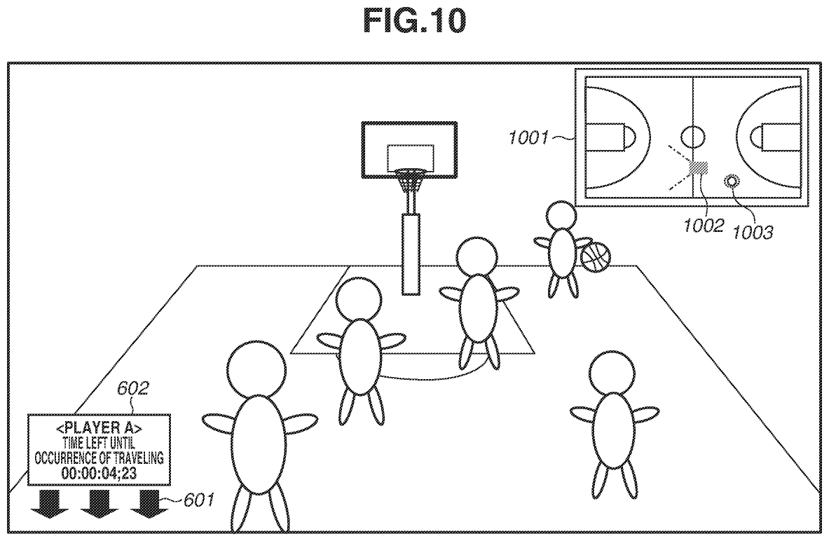

FIG. 10 illustrates an example of the image for the operator including an overhead view image 1001. Items other than the overhead view image 1001, a virtual camera 1002, and an event occurrence position 1003 are similar to those illustrated in FIG. 6, and the descriptions thereof will thus be omitted.

The overhead view image 1001 is an image of an imaging area viewed from the sky. In the present exemplary embodiment, the overhead view image 1001 is an image of a basketball court.

The virtual camera 1002 is an icon indicating the position of the virtual camera being operated by the operator. In the present exemplary embodiment, an icon indicating the angle of view of the virtual camera is displayed, but the present exemplary embodiment is not limited thereto.

The event occurrence position 1003 is an icon indicating the occurrence position of the event obtained by the event information obtaining unit 110. The occurrence position of the event that is to occur at a time later than the virtual viewpoint image generation time is displayed on the overhead view image 1001.

With this configuration, the event occurrence position relative to the position of the virtual camera can be identified in addition to the direction of the event occurrence position, so that the operator can more easily operate and guide the virtual camera to an appropriate position. For example, in a case where the operator wishes to move the virtual camera backward to capture an image of an event that is to occur behind the virtual camera, the operator can identify the distance between the virtual camera and the event occurrence position from the overhead view image and thus operate the virtual camera properly. According to the present exemplary embodiment, it is therefore possible to easily operate the virtual camera to include an event at an appropriate position in the virtual viewpoint image.

In the present exemplary embodiment, the court, the virtual camera, and the event occurrence position are displayed in the overhead view image, but the overhead view image is not limited thereto, and an icon indicating the subject may be displayed therein. In the present exemplary embodiment, the overhead view image is displayed in a superimposed manner on the image for the operator, but the display method is not limited thereto, and the overhead view image and the image for the operator may be displayed side by side.

While the exemplary embodiments of the present disclosure have been described in detail above, the exemplary embodiments of the present disclosure are not limited to the above-described exemplary embodiments. The above-described exemplary embodiments can be modified in various ways based on the gist of the present disclosure, and modifications thereof are not excluded from the scope of the present disclosure. For example, the above-described first to fourth exemplary embodiments can be combined as appropriate.

A computer program for implementing a part or all of the control and functions according to the above-described exemplary embodiments may be supplied to an image processing system via a network or various kinds of storage media. Then, a computer (a CPU or a micro processing unit (MPU)) in the image processing system may read and execute the program. In this case, the program and the storage medium storing the program are included in the exemplary embodiments of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-120653, filed Jul. 28, 2022, which is hereby incorporated by reference herein in its entirety.

What is claimed is:

1. An image processing apparatus comprising:
one or more memories storing instructions; and
one or more processors executing the instructions to:
obtain a position of a virtual viewpoint corresponding to a virtual viewpoint image to be generated based on images captured by a plurality of imaging apparatuses, a line-of-sight direction from the virtual viewpoint, and event information about an event occurring at a second time later than a first time, the event information indicating an occurrence position of the event; and
generate the virtual viewpoint image on which an image indicating the event information is superimposed and displayed, the virtual viewpoint image corresponding to the first time.

2. The image processing apparatus according to claim 1, wherein the event information includes information indicating the second time.

3. The image processing apparatus according to claim 2, wherein the event information includes information indicating a time period before the event occurs, the time period being a difference between the first time and the second time.

4. The image processing apparatus according to claim 3, wherein the image indicating the event information includes a number indicating the time period before the event occurs, and a three-dimensional virtual object or an icon indicating the occurrence position of the event.

5. The image processing apparatus according to claim 3, wherein, in the image indicating the event information displayed on the virtual viewpoint image, at least one of a color, a size, and a blinking period of the event information is changed depending on the time period before the event occurs. and

6. The image processing apparatus according to claim 1,
wherein the virtual viewpoint image is associated with a first time code,
wherein the event information is associated with a second time code,
wherein the first time code is a code indicating the first time, and
wherein the second time code is a code indicating the second time.

7. The image processing apparatus according to claim 1,
wherein the event information includes information indicating a name of the event,
wherein the image indicating the event information includes text indicating the name of the event.

8. The image processing apparatus according to claim 1,
wherein the event information includes information indicating a subject related to the event, and
wherein the image indicating the event information includes at least one of text, an icon, and an effect for identifying the subject related to the event.

9. The image processing apparatus according to claim 8, wherein the subject related to the event includes a plurality of subjects related to the event.

10. The image processing apparatus according to claim 1, wherein the one or more processors further execute the instructions to change, based on whether the occurrence position of the event is within an angle of view of the virtual viewpoint, the image indicating the event information to be superimposed and displayed on the virtual viewpoint image.

11. The image processing apparatus according to claim 10,
wherein, in a case where the occurrence position of the event is within the angle of view of the virtual viewpoint, the virtual viewpoint image includes a three-dimensional virtual object or an icon at the occurrence position of the event, and
wherein, in a case where the occurrence position of the event is not within the angle of view of the virtual viewpoint, the virtual viewpoint image includes a three-dimensional virtual object or an icon indicating a direction in which the occurrence position of the event is located.

12. The image processing apparatus according to claim 1, wherein the one or more processors further execute the instructions to obtain event information indicating an occurrence position of an event occurring at a time within a predetermined time period from the first time.

13. The image processing apparatus according to claim 12, wherein the one or more processors further execute the instructions to change the predetermined time period based on a priority of the event.

14. The image processing apparatus according to claim 1, wherein, at the second time, an image indicating guide information about the virtual viewpoint is superimposed and displayed on the virtual viewpoint image so that the occurrence position of the event is included within an angle of view of the virtual viewpoint.

15. The image processing apparatus according to claim 1, wherein the event is an event related to a sport or a concert.

16. The image processing apparatus according to claim 1, wherein the event information is obtained from the images captured by the plurality of imaging apparatuses, a global positioning system (GPS) sensor, or an audio recording apparatus.

17. The image processing apparatus according to claim 1, wherein the one or more processors further execute the instructions to generate the virtual viewpoint image including a captured image corresponding to a time later than the first time, or an overhead view image.

18. An image processing apparatus comprising:
one or more memories storing instructions; and
one or more processors executing the instructions to:
input viewpoint information indicating a position of a virtual viewpoint corresponding to a virtual viewpoint image to be generated based on images captured by a plurality of imaging apparatuses and a line-of-sight direction from the virtual viewpoint; and
display event information indicating an occurrence position of an event occurring at a time later than a time corresponding to the virtual viewpoint image, and indicating time information about a time period before the event occurs, and the virtual viewpoint image generated based on the viewpoint information.

19. The image processing apparatus according to claim 18, wherein the one or more processors further execute the instructions to superimpose and display, on the virtual viewpoint image, at least one of an image indicating the occurrence position of the event and an image indicating the time information about the time period before the event occurs.

20. An image processing system comprising:
one or more memories storing instructions; and
one or more processors executing the instructions to:
transmit viewpoint information indicating a position of a virtual viewpoint corresponding to a virtual viewpoint image to be generated based on images captured by a plurality of imaging apparatuses and a line-of-sight direction from the virtual viewpoint; and
receive event information indicating an occurrence position of an event occurring at a time later than a time corresponding to the virtual viewpoint image, and indicating time information about a time period before the event occurs, and the virtual viewpoint image generated based on the viewpoint information.

21. An image processing method comprising:
obtaining a position of a virtual viewpoint corresponding to a virtual viewpoint image to be generated based on images captured by a plurality of imaging apparatuses, a line-of-sight direction from the virtual viewpoint, and event information about an event occurring at a second time later than a first time, the event information indicating an occurrence position of the event; and
generating the virtual viewpoint image on which an image indicating the event information is superimposed and displayed, the virtual viewpoint image corresponding to the first time.

22. A non-transitory computer-readable storage medium storing a computer program for causing a computer to execute an image processing method, the image processing method comprising:
obtaining a position of a virtual viewpoint corresponding to a virtual viewpoint image to be generated based on images captured by a plurality of imaging apparatuses, a line-of-sight direction from the virtual viewpoint, and event information about an event occurring at a second time later than a first time, the event information indicating an occurrence position of the event; and
generating the virtual viewpoint image on which an image indicating the event information is superimposed and displayed, the virtual viewpoint image corresponding to the first time.
